(19) United States
(12) Patent Application Publication
(10) Pub. No.: US 2008/0205267 A1
(43) Pub. Date: Aug. 28, 2008

(54) Service Differentiation in the IP Multimedia Subsystem Utilizing Context-Aware Signaling

(75) Inventors: May El Barachi, Saint-Laurent (CA); Roch Glitho, Saint-Laurent (CA); Rachida Dssouli, Quebec (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/736,683

(22) Filed: Apr. 18, 2007

Related U.S. Application Data
(60) Provisional application No. 60/891,378, filed on Feb. 23, 2007.

(51) Int. Cl. H04L 12/26

(52) U.S. Cl. 370/230; 370/462

(57) ABSTRACT

A system and method for service differentiation enabling a user to express the level of importance of a session being established and change the level during the session while satisfying QoS profiles. An extension of the 3GPP IMS architecture includes a Session Prioritization Function (SPF) in communication with a S-CSCF and a Context Information Base (CIB) which provides network contextual information. Upon receiving a session initiation or change request, the S-CSCF queries the SPF for a resource allocation/deallocation decision. The SPF consults session prioritization policies and the contextual information to make an informed decision. If the load on the IMS network is normal or light, the SPF utilizes an upper limit policy to limit resources for each service class. Otherwise, the SPF limits the size of multi-party sessions and utilizes soft and hard preemption to transfer network resources between classes. The SPF may trigger the S-CSCF to re-negotiate media-format parameters if network contextual information changes.

### CROSS-REFERENCE TO RELATED APPLICATIONS: NOT APPLICABLE

This application claims the benefit of U.S. Provisional Application No. 60/891,378 filed on Feb. 23, 2007, the disclosure of which is incorporated herein by reference.

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

This invention relates to IP-based telecommunication systems. More particularly, and not by way of limitation, the invention is directed to a system and method for service differentiation in the IP Multimedia Subsystem (IMS).

The IMS is an architectural framework originally designed by the Third Generation Partnership Project (3GPP) for evolving mobile networks beyond GSM and delivering IP multimedia services to end users. In its original form, IMS provided an approach for delivering “Internet Services” over GPRS. This vision was subsequently updated by 3GPP, 3GPP2, and TISPAN by providing requirements for support of networks other than GPRS such as Wireless LAN, CDMA2000, and Fixed Line. To ease the integration with the Internet, the IMS as far as possible utilizes Internet Engineering Task Force (IETF) protocols such as the Session Initiation Protocol (SIP) and the Common Open Policy Service (COPS) protocol. The IMS supports the delivery of multimedia services to any access type (fixed, mobile, or wireless), by relying on an IP backbone for traffic transport.

The terms “service differentiation” and “Quality of Service (QoS) provisioning” are used interchangeably to signify the ability to provide different treatment to different classes of traffic (or service), depending on their QoS profiles. A QoS profile represents a set of guarantees, which are required by a particular class of traffic/service on a set of QoS parameters.

There are two main criteria utilized for service differentiation: the traffic requirements in terms of resources (for example, audio vs. video vs. text), and the importance of the service session from the user perspective (for example, regular vs. premium calls). Since different multimedia services have different QoS requirements and users may establish sessions with different levels of importance, service differentiation becomes a key issue in IMS-based 3G networks. At the core network level, the focus has traditionally been on the differentiation between classes of traffic in the media plane. Adding another level of differentiation, signaling level schemes enabling the differentiation between classes of sessions within the same traffic class, has also been proposed. However, these conventional solutions have several shortcomings. First, they lack flexibility in terms of QoS negotiation. For example, they may enable the selection of the service class per subscription, but not per call. Additionally, once a service class has been negotiated for a session, they may not allow the service class to be changed during the ongoing session. Second, the conventional solutions may provide for preferential treatment only at the beginning of sessions (not during sessions). Third, the conventional solutions fail to consider the concepts of multimedia and multiparty sessions, which are important in a 3G environment.

What is needed in the art is a system and method for service differentiation in the IMS that overcomes the limitations of the prior art. The present invention provides such a system and method.

### BRIEF SUMMARY OF THE INVENTION

In one embodiment, the present invention defines three new classes of calls/sessions offering different priorities/guarantees to the user. Service differentiation is achieved at the session signaling level by relying on a context-aware resource allocation strategy, and users are offered the flexibility to choose the service class for each call as well as the ability to change this class during the session. An extension to the 3GPP IMS architecture is utilized to realize the service differentiation scheme. In the embodiments described herein, SIP and COPS are utilized as implementation technologies. Unlike other signaling level schemes, the present invention offers flexible QoS negotiation mechanisms to the user, provides preferential treatment at the beginning and during sessions, and takes into consideration the characteristics of the multimedia, multiparty service environment offered by 3G networks.

Thus, in one aspect, the present invention is directed to a method of service differentiation in an IMS network. The method includes the steps of defining a plurality of classes of differing priorities for sessions having different QoS profiles; and using two resource management techniques to enable preferential treatment at the beginning and during sessions, namely: call admission control and media parameter control. New calls (or requests to join ongoing calls) are granted/denied access to the core network by the call admission control mechanism, based on a call admission policy. The media parameter control mechanism is used to control the format of the media streams exchanged in (some of) the admitted sessions, in order to sustain their perceived media quality. The objective of these techniques is to optimize the utilization of resources while satisfying the sessions' QoS profiles. Leveraging contextual information in the decision making process, those techniques are able to adapt to different network situations and use resources efficiently.

In another aspect, the present invention is directed to a system for service differentiation in an IMS network. The system includes a Session Prioritization Function (SPF) in communication with a Serving Call/Session Control Function (S-CSCF), wherein the SPF is adapted to make informed resource allocation/re-allocation decisions when queried by the S-CSCF. The system also includes a Context Information Base (CIB) in communication with the SPF and with sources for network contextual information, wherein the CIB is adapted to obtain and store network contextual information and provide the contextual information to the SPF. The SPF then utilizes the network contextual information to make the informed decisions.

In another aspect, the present invention is directed to a Session Prioritization Function (SPF) for making informed resource allocation/re-allocation decisions in an IMS network. The SPF includes means for receiving from a S-CSCF, a request for a session admission decision; means responsive to the request for obtaining network contextual information from a CIB; means for utilizing the network contextual information to make an informed session admission decision; and means for sending the informed session admission decision to the S-CSCF. The means for utilizing the network contextual information to make an informed session admission decision may include a repository for session prioritization policies, and logic for applying the network contextual information to the session prioritization policies to formulate the informed admission decision. The SPF may also include means for sending triggers to a S-CSCF to re-negotiate the parameters of ongoing sessions (in terms of media format), in response to important variations in the network capacity, based on the information obtained from the CIB.

### BRIEF DESCRIPTION OF THE SEVERAL VIEWS OF THE DRAWING

In the following, the essential features of the invention will be described in detail by showing preferred embodiments, with reference to the attached figures in which:

FIG. 1 (Prior Art) is a simplified block diagram of the existing IP multimedia subsystem;

FIG. 2 is a chart illustrating three classes of calls provided by the present invention and their corresponding QoS profiles;

FIG. 3 is a simplified block diagram of an exemplary embodiment of the system of the present invention;

FIGS. 4A and 4B are portions of a flow chart illustrating the steps of a call admission control process in an exemplary embodiment of the method of the present invention;

FIG. 5 is an algorithm illustrating the steps of a media parameter control process in an exemplary embodiment of the method of the present invention;

FIG. 6 is a simplified block diagram of the components of the SPF and the CIB of the present invention;

FIG. 7 is a call flow diagram illustrating the flow of messages during a successful session initiation without an attempt to control ongoing sessions; and

FIG. 8 is a call flow diagram illustrating the flow of messages during a successful session initiation after downgrade of an ongoing session.

### DETAILED DESCRIPTION OF THE INVENTION

In one embodiment, the present invention provides differentiation between classes of “regular” calls/sessions and overcomes the shortcomings of the conventional signaling-level schemes. The terms “session” and “call” are used herein interchangeably to signify the exchange of different types of media streams between two or more participants, in a conversational mode (for example, VoIP call, multimedia conference, multiparty game, and the like). The invention offers the user the flexibility to choose the service class for each call, as well as the ability to change the call category during an active session. Furthermore, the resource allocation strategy used to achieve call differentiation is distinguished by its ability to control different aspects of the communication (taking into consideration the concepts of multimedia and multiparty sessions) and adapt to different network situations. Performing the differentiation at the signaling level enables a high level of control over the different communication aspects, while context-awareness (i.e. the ability to use situational information for operations and decision making) provides adaptability.

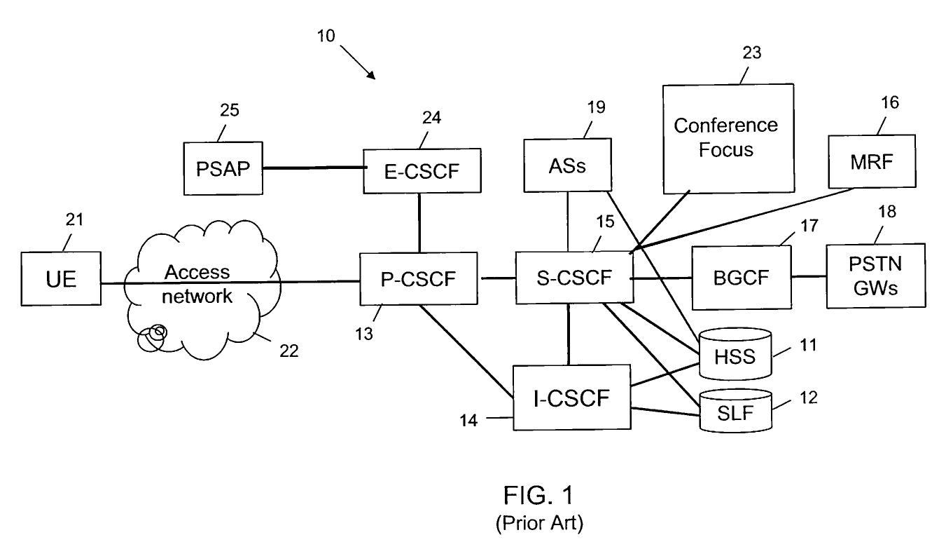

FIG. 1 is a simplified block diagram of the existing IP multimedia subsystem 10. The architecture consists of five basic types of functional entities, namely: databases, signaling entities, media handling entities, interworking entities, and entities providing value-added (or specialized) services. The databases include a Home Subscriber Server (HSS) 11 and a Subscription Locator Function (SLF) 12. The signaling entities include several SIP servers, collectively known as Call/Session Control Functions (CSCFs). There are three types of CSCFs: a Proxy-CSCF (P-CSCF) 13, an Interrogating-CSCF (I-CSCF) 14, and a Serving-CSCF (S-CSCF) 15. The media handling entities include a Media Resource Function (MRF) 16. The interworking entities include a Breakout Gateway Control Function (BGCF) 17 and one or more PSTN gateways (18). Finally, the entities providing value-added or specialized services include one or more Application Servers (ASs) 19. A user accesses the IMS with a User Equipment (UE) 21 operating through an access network 22.

Of special interest for the present invention are the signaling entities (i.e., the various CSCFs) and the entities providing specialized services. In terms of specialized services, two entities have been proposed as extensions to the IMS architecture, namely: a Conference Focus 23 which offers centralized conferencing capabilities using SIP; and an Emergency-CSCF (E-CSCF) 24, which was introduced to enable support for emergency sessions in the IMS by connecting to a Public Safety Answering Point (PSAP) 25.

In order to achieve service differentiation, resource management techniques are used to allocate resources to the different classes, based on their QoS requirements. Several resource management techniques have been previously proposed at both access and core network levels. Examples include: admission control; rate/power control; queuing/scheduling; as well as policing/shaping. Among those techniques, call admission control is of particular interest for the present invention because it can be used for signaling-level access control and session prioritization.

In general, existing call admission strategies/policies limit access to resources by low priority classes in order to protect those resources for the high priority classes. The main concern about these approaches is that they reduce the utilization and revenue generation potential of networks by rejecting traffic from low priority users. A radically different approach, which is also being investigated is preemption. A preemptive policy admits users to the network whenever resources are available, then interrupts the flows of low priority users (hard-preemption) or reduces the quality of their sessions (soft-preemption), to free resources for high priority users when there are no spare resources to accommodate them. An optimal preemptive policy can use capacity more efficiently and is capable of adapting to important variations in load by transferring/re-assigning resources between different classes. The main issue with preemption is the irritation of low priority users (who are preempted). However, this problem can be offset with the right incentives (for example, credits and lower subscription rates). The present invention combines the benefits of a conservative policy (the upper limit policy) and a preemptive policy to achieve call admission control. In conjunction with call admission control (which enables preferential treatment at the beginning of sessions), the present invention provides a new technique (media parameter control) to enable preferential treatment during sessions.

In one embodiment, the present invention preferably introduces three classes of calls (referred to as silver, gold, and platinum), offering different priorities/guarantees to the user. Five differentiating factors are used to distinguish between these classes, namely:
Call blocking probability (CBP): The probability that a new call is blocked and not allowed admission to the core network. This factor reflects the priority a call gets (based on its importance) when being admitted to the network.
Forced call termination probability (FCTP): The probability that an ongoing call is terminated by the core network. This factor addresses the probability of hard preemption of one or more ongoing sessions in order to free resources for new (more important) ones.
Multiparty session ability to grow: The upper limit on the number of participants that can participate in a multiparty session. Some sessions may be allowed unlimited growth, while others may be subject to restrictions in terms of the number of participants.
Media type guarantee: The ability to sustain a call with a certain media type, without downgrade (i.e., soft preemption) to another type (for example dropping from video to voice). Some sessions may offer guaranteed audio and video communications while in others, video streams could be subject to downgrade.
User-perceived media quality: The quality of the media transmission as perceived by the user. Some sessions could offer a quality which varies with the network conditions, while others could offer a sustained quality (for example no freezing, interruptions, and the like).

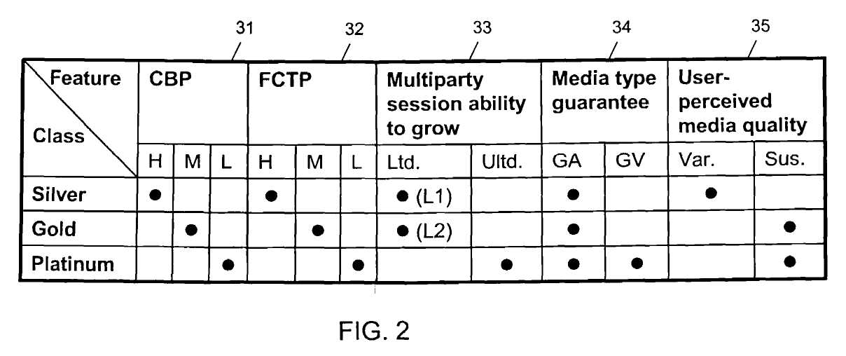

FIG. 2 is a chart illustrating the three classes of calls and their corresponding QoS profiles defined based on the five differentiating factors above. As shown, the silver class offers the lowest QoS profile, with high call blocking 31 and forced call termination probabilities 32, size-limited multiparty sessions 33, a media type guarantee 34 with guaranteed audio (GA) communications but not guaranteed video (GV) communications, and variable user-perceived media quality 35. The gold class brings improvements in terms of medium call blocking 31 and forced call termination probabilities 32, as well as user-perceived media quality 35 (which is sustained by the network for this service class). In terms of gold multiparty session size, it is still limited although the limit is higher than for the silver class (i.e., L2>L1). It should be noted that L1 and L2 are soft limits (meaning they are imposed only in high loading conditions and are operator defined). Finally, the best priorities/guarantees can be obtained by using the platinum service class. The platinum class offers low call blocking 31 and forced call termination probabilities 32, unlimited size for multiparty sessions 33, a media type guarantee 34 with guaranteed audio and video communications, as well as sustained user-perceived media quality 35. The user subscription should indicate the highest service class (HSC) that the user is allowed to use. Any class up to and including the HSC can be chosen for each call. Furthermore, the call category can be dynamically changed (by the user) during an active session.

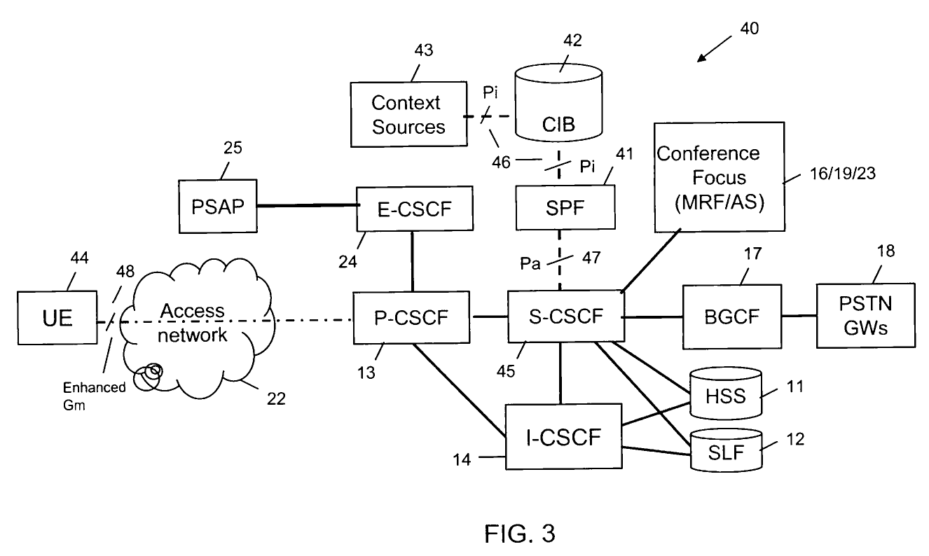

FIG. 3 is a simplified block diagram of an exemplary embodiment of the system 40 of the present invention. In this embodiment, the invention extends the standard IMS architecture with two new functional entities, namely: a Session Prioritization Function (SPF) 41 and a Context Information Base (CIB) 42. The CIB is a support entity, which is responsible of the management of the contextual information needed for the operation of the SPF. The CIB maintains a global view of the network context and performs several tasks such as information acquisition from relevant context sources 43; information modeling and processing; and information dissemination via queries and subscriptions/notifications. The SPF makes resource allocation/re-allocation decisions, taking in consideration the contextual information it gets from the CIB and the sessions' QoS profiles. The resource allocation/re-allocation decisions are regulated by session prioritization policies (SPP), which are discussed in more detail below.

Service differentiation is achieved as follows: when a new call (of a certain class) is attempted by an enhanced UE 44, the request goes through the P-CSCF 13 to an enhanced S-CSCF 45 which checks the user profile in the HSS 11 to determine whether the user is entitled to the service type and service class requested. If the request is not authorized, it is rejected. Otherwise, the S-CSCF attempts to admit the call into the network by communicating with the SPF 41. If resources are available, the SPF renders a positive decision and the call is established normally. If no resources are available, the SPF either rejects the call admission request (resulting in the blocking of the call) or triggers a network S-CSCF to downgrade or preempt (one or more) ongoing calls in order to free resources for the new call, which is admitted afterwards.

After session establishment, and depending on the session class, the SPF 41 may trigger the enhanced S-CSCF 45 to re-negotiate the session parameters in order to sustain the session's perceived quality. In the case of an attempt to join (or refer another party to) an ongoing multiparty session, the same procedure is followed. The only difference is that, in the case of lack of resources, the SPF first checks the session size before attempting to free resources for the new request. If the size limit has been reached, the admission request is rejected. The case of call category change is special in the sense that resources have already been allocated to the call, but a change in the guarantees on those resources is requested. In that case, if the user is entitled to the new service class requested, the request is accepted and the call category is updated at the SPF and the S-CSCF.

In order to carry out these operations, some enhancements are made to the UE 44 and the S-CSCF 45. The UE is enhanced with the ability to label session initiation requests with the call category, as well as issue a session category change request. The S-CSCF is enhanced with the ability to communicate with the SPF 41 for call admission decisions and the ability to receive triggers (concerning the control of ongoing calls) and then take the necessary actions. As refinement to existing mechanisms implemented by the S-CSCF, it is augmented with the ability to authorize the service class requested by the user by checking his/her profile, and the ability to include the call category as part of the billing information it sends to the charging collection function (CCF). This last may use this information to implement a suitable charging scheme.

Two new interfaces are introduced in order to enable the interaction between the new and existing entities, namely: a Pi interface 46 and a Pa interface 47. The Pi interface is utilized between the CIB 42 and the context sources 43. The Pi interface is also utilized between the CIB and the SPF 41. This interface is used for contextual information exchange using queries and subscriptions/notifications. The SIP event notification framework may be used on the Pi interface, because the SIP framework provides the needed functionality and relies on a protocol (i.e., SIP) which is already supported in the IMS infrastructure. The Pa interface, on the other hand, is utilized for the exchange of information related to call admission decisions, between the SPF 41 and the S-CSCF 45. COPS may be utilized on this interface because COPS is already supported in the IMS and provides a policy enforcement framework. According to the COPS framework, the S-CSCF acts as a policy enforcement point (PEP) and the SPF as a policy decision point (PDP), operating in the outsourcing mode. In addition to the interactions carried out via the new interfaces, other interactions related to QoS negotiation occur between the UE 44 and the access network 22 (over an enhanced Gm interface 48), using SIP and SIP extensions. In fact, since the differentiation occurs at the signaling level, the same protocol (i.e., SIP) is used for session control and QoS negotiation, which are combined in the same step.

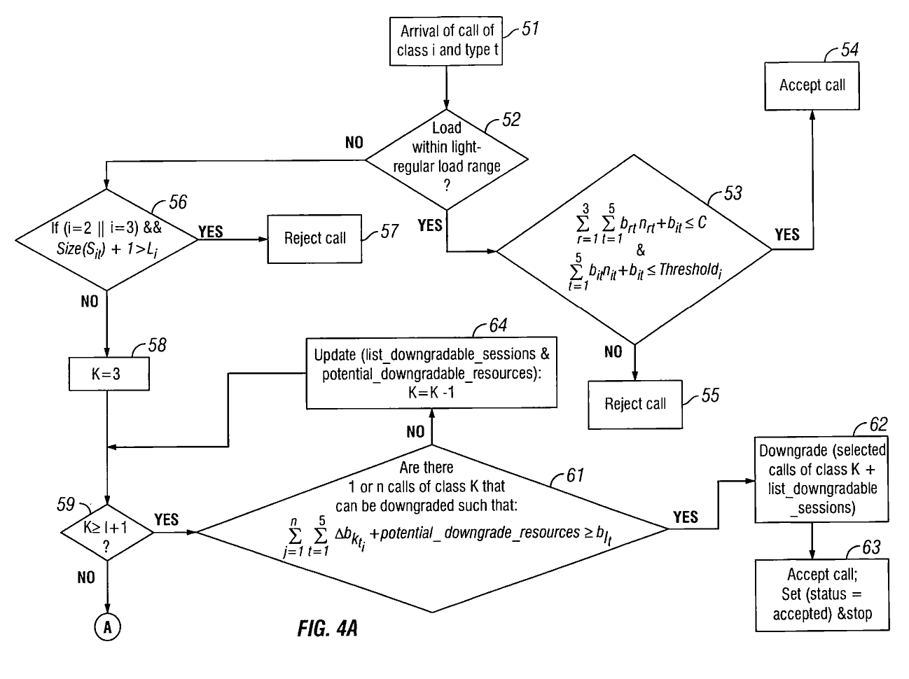

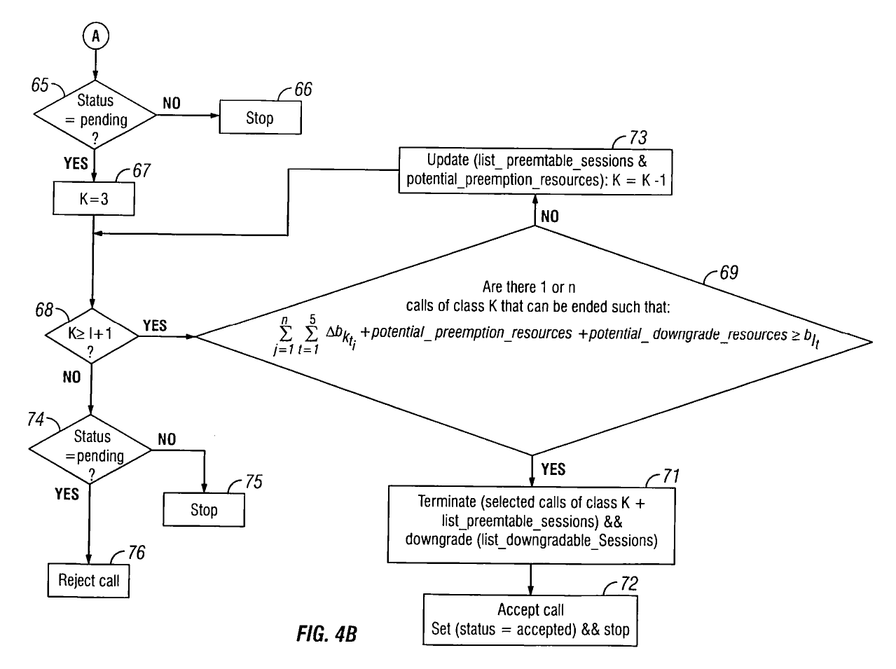

FIGS. 4A and 4B are portions of a flow chart illustrating the steps of a call admission control process in an exemplary embodiment of the method of the present invention. The preferred call admission control process implements a combination of the upper limit policy and the preemptive policy along with an overload prevention mechanism. As long as the network load remains within its planned value (i.e., light to regular load), the upper limit policy is used to limit the amount of resources that can be accessed by each class. This is accomplished by putting a threshold over the amount of resources that can be accessed by each class. However, when the load exceeds its planned value (i.e., in high load or in crisis situations), session size control is first attempted for overload prevention/reduction, then a mix of soft and hard preemption is used to enable the adaptation to this high load condition by transferring resources between different classes. It should be noted that, preemption (either hard or soft) is carried in a prioritized manner. This implies that lower priority calls are preempted first, while high priority calls are preempted last; noting that a session can trigger the downgrade/termination of (one or more) lower priority sessions.

Referring to FIG. 4A, at step 51 a call of class i and type t arrives at the network. At step 52, it is determined whether the traffic load in the network is within a light to regular load range. If so, the process moves to step 53 where an upper limit policy is applied utilizing a threshold-based algorithm in which bᵣₜ is the bandwidth required by a session of class r and type t; nᵣₜ is the number of active sessions of class r and type t; bit is the bandwidth required by a session of class i and type t; C is the network bandwidth capacity; nᵢₜ is the number of active sessions of class i and type t; and Thresholdᵢ is the limit on the amount of bandwidth that can be used by sessions of class i. If the conditions in block 53 are met, the networks accepts the call at step 54. Otherwise, the call is rejected at step 55.

If it is determined at step 52 that the traffic load in the network is not within a light to regular load range (i.e., the load is heavy), the process moves to step 56 where it is determined whether the call is attempting to join a multi-party session (Sᵢₜ) that has reached its size limit (Lᵢ). If so, the call is rejected at step 57. If not, K is set equal to 3 at step 58 and it is determined at step 59 whether K is greater than or equal to I+1. If so, the process moves to step 61 where it is determined whether there are 1 or n calls of class K that can be downgraded to meet the condition shown in block 61. If so, the process moves to step 62 where the invention downgrades selected calls of class K plus a list of downgradable sessions. The process then moves to step 63 where the call is accepted. If it is determined at block 61 that there are not 1 or n calls of class K that can be downgraded to meet the condition shown in block 61, the process moves to step 64 where the invention updates the list of downgradable sessions and potential downgradable resources, and sets K equal to K−1. The process then returns to step 59.

If it is determined at step 59 that K is not equal to or greater than I+1, the process moves to FIG. 4B, step 65 where it is determined whether the status of the call is pending. If not, the process stops at step 66. If the status is pending, the process moves to step 67 where K is set equal to 3. At step 68, it is determined whether K is greater than or equal to I+1. If so, the process moves to step 69 where it is determined whether there are 1 or n calls of class K that can be ended to meet the condition shown in block 69. If so, the process moves to step 71 where the invention terminates selected calls of class K plus a list of preemptable sessions, and downgrades the list of downgradable sessions. At step 72, the call is then accepted.

If it is determined at block 69 that there are not 1 or n calls of class K that can be ended to meet the condition shown in block 69, the process moves to step 73 where the invention updates the list of preemptable sessions and potential preemptable resources, and sets K equal to K−1. The process then returns to step 68. If it is determined at step 68 that K is not equal to or greater than I+1, the process moves to step 74 where it is determined whether the status of the call is pending. If not, the process stops at step 75. If the status is pending, the process moves to step 76 where the call is rejected.

As described, the system includes three algorithms, namely: a threshold-based admission algorithm, a preemption-based admission algorithm, and a session size control algorithm.

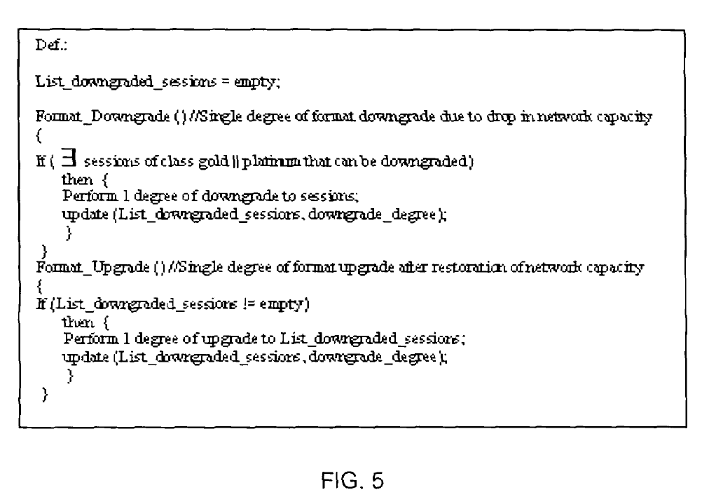

FIG. 5 is an algorithm illustrating the steps of a media parameter control process in an exemplary embodiment of the method of the present invention. Media parameter control consists of modifying the characteristics of some of the ongoing sessions (in terms of media format/codec used) in response to important variations in the network capacity, by triggering the re-negotiation of the session parameters between the involved parties. When an important drop in the network capacity is detected, a format downgrade procedure is invoked to trigger the re-negotiation of the session parameters to a media format that suits the network situation (i.e., a format that consumes fewer resources). The goal of this procedure is to prevent the degradation of the session's performance in terms of user perceived quality, reducing by the same token the session's load on the network. Upon a re-increase in the network capacity, a format upgrade procedure is invoked to restore the initial session characteristics. It should be noted that, several degrees of downgrade/upgrade may be used, depending on fluctuations in the network situation and the media codecs supported by the terminals. Contrarily to soft and hard preemption events, format upgrade/downgrade events are performed transparently to end-users, to avoid their disturbance by the frequent upgrade/downgrade notifications.

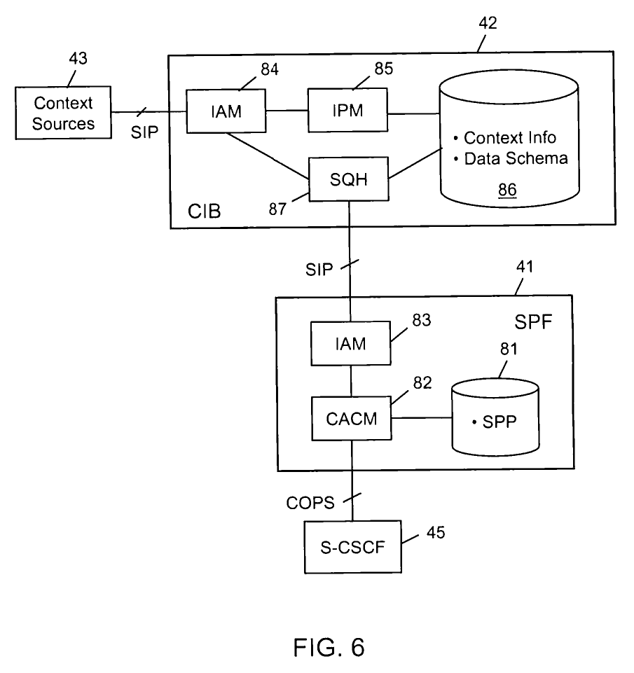

FIG. 6 is a simplified block diagram of the components of the SPF 41 and the CIB 42. The SPF includes a repository for Session Prioritization Policies (SPP) 81, a Call Admission/Control Module (CACM) 82, and an Information Access Module (IAM) 83. The CACM acts as a PDP, making informed decisions about the admission of new calls and the control of ongoing calls. The CACM accesses the policy repository to consult the SPPs and uses the IAM to collect the needed contextual information from the CIB.

The CIB 42 includes a second IAM 84, similar to the IAM 83 utilized in the SPF 41. The second IAM 84 is used in the CIB to collect raw contextual information from the context sources 43. Once the context information is collected, the IAM 84 passes the information to an Information Processing Module (IPM) 85, which includes a rule-based reasoning agent and an XML-formatter. Once processed by the IPM, the information is stored in a data store 86 (also containing the data schema), where it is accessed by a Subscriptions and Queries Handler (SQH) 87 in response to requests received from the SPF. Following the initial subscription of the SPF to the CIB, the SQH informs the IAM about the pieces of information that need to be managed.

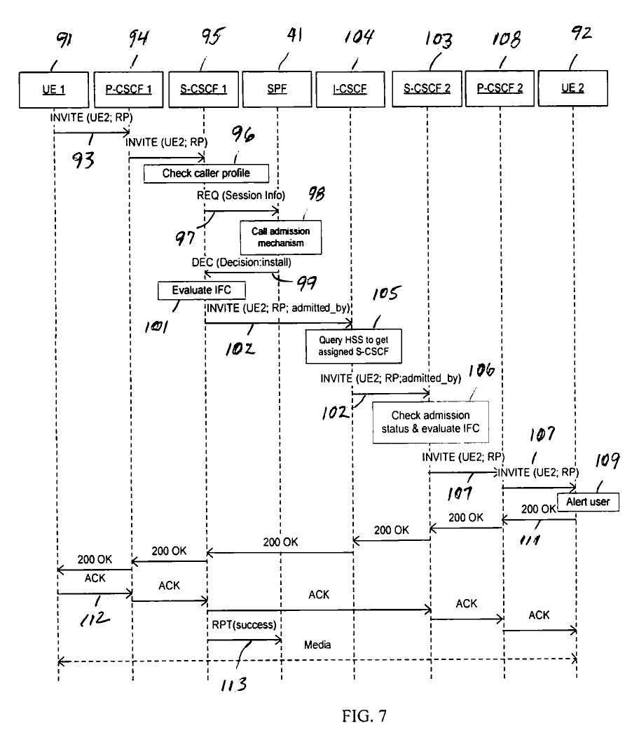

FIG. 7 is a call flow diagram illustrating the flow of messages during a successful session initiation without an attempt to control ongoing sessions. The process begins when UE-1 91 attempts to establish a session of a certain category with UE-2 92. UE-1 sends a SIP INVITE message 93 with a resource-priority (RP) header set according to the session category, to its P-CSCF (i.e., P-CSCF-1) 94. The RP header is a proposed SIP extension indicating the priority of the session in terms of access to SIP-signaled resources. In this example, sessions are assigned the following priority values according to the Q.735 namespace: platinum=Q735.1; gold=Q735.2; and silver=Q735.3. The P-CSCF-1 ignores the RP header and forwards the SIP INVITE message to the assigned S-CSCF (i.e. S-CSCF-1) 95, which checks the caller profile at 96 to ensure the user is entitled to the service requested. Afterwards, S-CSCF-1 sends a call admission request to the SPF 41 using a COPS REQ message 97 (including the session information). The CACM 62 in the SPF then makes an admission decision at 98. In this case, the call is admitted, and an “install” decision is sent to S-CSCF1 (using a COPS DEC message 99).

S-CSCF-1 95 inserts a tag (in the record-route header) indicating the address of the SPF 41 that has admitted the request, evaluates the initial filter criteria (IFC) at 101, and then forwards an INVITE message 102 to the callee's S-CSCF (i.e., S-CSCF-2) 103, via the local I-CSCF 104. The I-CSCF queries the HSS at 105 to obtain the S-CSCF assigned to UE-2 (i.e., S-CSCF-2) 103, and forwards the INVITE to S-CSCF-2. After checking the admission tag, and evaluating the IFC at 106, S-CSCF-2 determines that the call has already been admitted in this domain and completes the session establishment procedure normally. S-CSCF-2 forwards an INVITE 107 to UE-2 92 via its P-CSCF (i.e., P-CSCF-2) 108. The UE-2 user is alerted at 109. UE-2 then sends a 200 OK message 111, which is forwarded to UE-1 91. UE-1 returns an acknowledgment message 112, which is forwarded to UE-2. The session is then established. Following the session establishment, S-CSCF-1 95 returns a COPS RPT message 113 to the SPF 41 indicating that it has enforced the SPF decision.

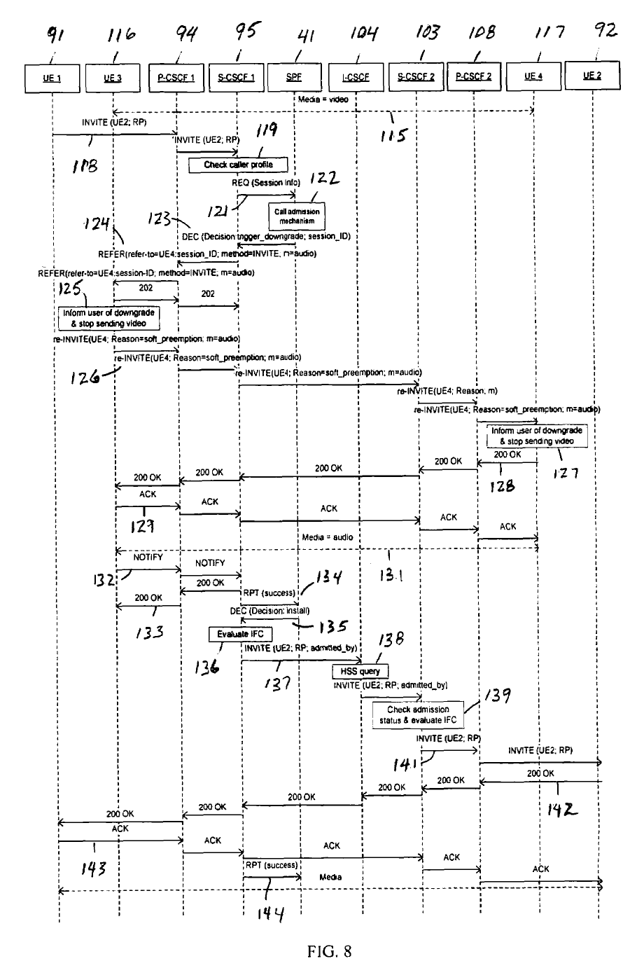

FIG. 8 is a call flow diagram illustrating the flow of messages when an ongoing session (a video session 115 between UE-3 116 and UE-4 117) must be downgraded in order to free resources for a new session to be established (between UE-1 91 and UE-2 92). It is assumed that UE-1 and UE-3 are serviced by P-CSCF-1 94 and S-CSCF-1 95, while UE-2 and UE-4 are serviced by P-CSCF-2 108 and S-CSFC-2 103. The process begins when UE-1 91 attempts to establish a session of a certain category with UE-2 92. UE-1 sends an INVITE message 118 with the RP header set according to the session category, to the P-CSCF-1 94. The P-CSCF-1 ignores the RP header and forwards the INVITE message to the S-CSCF-1 95, which checks the user profile at 119 to ensure the user is entitled to the service requested. Afterwards, the S-CSCF-1 sends a call admission request to the SPF 41 using a REQ message 121 (including the session information). The CACM 62 in the SPF then makes an admission decision at 122.

In this case, the SPF 41 sends a DEC message 123 with a “trigger downgrade” decision to S-CSCF-1 95 in order to modify the decision made about the (previously admitted) session between UE-3 and UE-4. After receiving the downgrade decision, S-CSCF-1 sends a SIP REFER message 124 instructing UE-3 to contact UE-4 in order to re-negotiate the parameters of the session (from video to audio). At 125, UE-3 informs the UE-3 user of the downgrade and stops sending video. UE-3 then complies with the downgrade instruction by sending a SIP re-INVITE 126 to UE-4, containing “audio” as a new media type, and a reason header indicating “soft preemption” as a reason for the re-negotiation. At 127, UE-4 informs the UE-4 user of the downgrade and stops sending video. UE-4 then sends a 200 OK message 128 which is forwarded to UE-3. UE-3 returns an Acknowledgment (ACK) message 129 to UE-4. The session is then re-negotiated as an audio session 131.

UE-3 reports the successful re-negotiation of the session by sending a notification to S-CSCF-1 95 (using a SIP NOTIFY message 132). S-CSCF-1 returns a 200 OK message 133 and then informs the SPF 41 that the video resources have been made available by sending an RPT message 134. The SPF then authorizes the admission of the new call and sends a DEC message 135 with an “install” decision to S-CSCF-1. The S-CSCF-1 evaluates the IFC at 136, and then forwards an INVITE message 137 to S-CSCF-2 103, via the local I-CSCF 104. The I-CSCF queries the HSS at 138 to obtain the S-CSCF assigned to UE-2 (i.e., S-CSCF-2) 103, and forwards the INVITE to S-CSCF-2. After checking the admission tag, and evaluating the IFC at 139, S-CSCF-2 completes the session establishment procedure normally. S-CSCF-2 forwards an INVITE 141 to UE-2 92 via P-CSCF 108. UE-2 then sends a 200 OK message 142, which is forwarded to UE-1 91. UE-1 returns an acknowledgment message 143, which is forwarded to UE-2. The session is then established. Following the session establishment, S-CSCF-1 95 returns a COPS RPT message 144 to the SPF 41 indicating that it has enforced the SPF decision.

The case of hard preemption is similar, except that an ongoing session is terminated to allow the establishment of the new session. It should be noted that both two-party sessions and multi-party sessions could be downgraded or preempted, to enable the establishment of new sessions. Finally, the case of successful session category change is similar to the case illustrated in FIG. 6. The only difference is that instead of issuing a new INVITE request, the UE requesting a call category change issues a re-INVITE with the new call category, to re-negotiate the parameters of the session (from “category 1” to “category 2”).

There are several unsuccessful session initiation scenarios. For example, there is the scenario in which the SPF 41 determines that there are not enough resources and that no alternative actions can be taken to free some resources for the new session. In this case, a “remove” decision with the appropriate flag is sent to the S-CSCF 45, which sends a 488 “Not acceptable here” response message with an “insufficient resources” warning header to the UE 44 (via the P-CSCF 13). After failure of the operation, the UE may wait for an arbitrary amount of time and then try again. A second scenario is when a UE tries to establish a session that violates the UE's subscription profile (for example, the UE requests a higher service class than what was subscribed for). In this case, the S-CSCF 45 sends a 403 “Forbidden” response which is relayed to the UE 44. After receiving this response, the UE should give up and not try again. It should be noted that the SPF is not contacted in this scenario, since a “forbidden” session request should not be considered for admission. A third scenario is when the S-CSCF 45 does not recognize the resource priority value (or namespace) in the UE's request. A 417 “unknown resource priority” response carrying the list of the acceptable priority values (in the accept resource priority header) is returned to the UE 44, in this case. The UE may attempt to re-initiate the session, with one of the acceptable priority values.

Finally, failure scenarios occur when the callee does not answer or is busy with another call. Regular SIP procedures are followed in these cases. However, in order to maximize the chances of priority call establishment, the following may be attempted: If the callee does not answer, but has subscribed to a call redirection service, the call may be diverted to an alternate party. If the callee is busy with a lower priority call, the lower priority call may be preempted by the callee's UE in order to allow the establishment of the new call. However, this necessitates the implementation of a preemption mechanism at the UE level.

All of the failure scenarios described above also apply to multiparty sessions, in addition to two other scenarios which are specific to the multiparty case. The first scenario occurs when a user tries to join an ongoing multiparty session, while its size limit has been reached. In this case, the SPF 41 sends a “remove” decision with the appropriate flag to the S-CSCF 45, which sends a 488 “Not acceptable here” response message with a “size limit reached” warning header to the UE 44 (via the P-CSCF 13). In this case, the UE may wait a certain amount of time before trying again. The second case is when a non-authorized participant tries to modify the session category. In this case, the SPF sends a “remove” decision with the appropriate flag to the S-CSCF, which sends a 403 “Forbidden” response to the UE. After receiving this response, the UE should give up and not try again.

The system of the present invention enables the differentiation between the three classes of calls defined by prioritizing their access to the core network resources. The system also enables flexible interactions by offering the user the ability to select the service category for each call, as well as the ability to dynamically change the call category during an active session. In order to efficiently utilize the network's resources, the system dynamically allocates resources to different classes of calls, taking into consideration the network situation and the QoS profile of each session. Additionally, the system guarantees the consistency of the treatment offered to a given class of calls by offering preferential treatment at the beginning and during sessions. Finally, the system demonstrates satisfactory performance in terms of call setup time and introduces reasonably low complexity and overhead.

It should be readily recognized that the present invention may be implemented as hardware, software, firmware, or combinations of these embodiments. Although preferred embodiments of the present invention have been illustrated in the accompanying drawings and described in the foregoing Detailed Description, it is understood that the invention is not limited to the embodiments disclosed, but is capable of numerous rearrangements, modifications, and substitutions without departing from the scope of the invention. The specification contemplates any all modifications that fall within the scope of the invention defined by the following claims.

What is claimed is:

1. A method of service differentiation in an IP Multimedia Subsystem (IMS) network, said method comprising the steps of:
defining a plurality of call classes of differing priorities for calls having different Quality of Service (QoS) profiles;
receiving a request from a User Equipment (UE) to establish a new call or join an ongoing call, said request including a requested call class;
granting by a call admission control mechanism, the UE's request only if a traffic load for the requested call class would remain in compliance with a call admission policy following admission of the call; and
controlling by a media parameter control mechanism, formats of media streams exchanged in selected admitted calls in order to sustain the perceived media quality of the selected calls;
wherein utilization of network resources is optimized while satisfying the QoS profiles for admitted calls.

2. The method according to claim 1, wherein the step of granting the UE's request by a call admission control mechanism includes establishing an upper limit policy, wherein an upper limit is established on the amount of network resources that can be utilized for calls of each class, and when a given class has utilized its limit of network resources, additional requests for calls of the given class are rejected.

3. The method according to claim 1, wherein:
the step of granting the UE's request by a call admission control mechanism is performed when a load on the IMS network is less than a predefined level; and
the step of controlling formats of media streams by a media parameter control mechanism is also performed if the load on the IMS network is more than the predefined level.

4. The method according to claim 1, wherein the step of controlling formats of media streams by a media parameter control mechanism includes making network resources available for calls of higher priority by downgrading ongoing calls of lower priority to calls requiring fewer network resources.

5. The method according to claim 1, wherein the step of controlling formats of media streams by a media parameter control mechanism includes making network resources available for calls of higher priority by terminating ongoing calls of lower priority.

6. The method according to claim 1, wherein the step of receiving the UE's request to establish a new call includes:
checking by the S-CSCF, a caller profile to determine whether the UE is authorized to conduct calls of the requested class; and
if the UE is authorized, obtaining by the S-CSCF, an admission decision from a Session Prioritization Function (SPF).

7. The method according to claim 6, wherein the step of obtaining an admission decision from the SPF includes:
receiving by the SPF, a request from the S-CSCF for an admission decision;
obtaining by the SPF, contextual information regarding conditions in the IMS network;
utilizing the contextual information to formulate an informed admission decision; and
sending the informed admission decision to the S-CSCF.

8. The method according to claim 6, further comprising:
receiving by the S-CSCF, a request from the UE to change the class of an ongoing call, wherein the call change request is labeled with a new requested class;
checking by the S-CSCF, the caller profile to determine whether the UE is authorized to conduct calls of the new requested class; and
if the UE is authorized, obtaining by the S-CSCF, a second admission decision from the SPF for the new requested class.

9. A system for service differentiation in an IP Multimedia Subsystem (IMS) network, said system comprising:
a Session Prioritization Function (SPF) in communication with a Serving Call/Session Control Function (S-CSCF), wherein the SPF is adapted to make informed resource allocation/deallocation decisions when queried by the S-CSCF; and
a Context Information Base (CIB) in communication with the SPF and with sources for network contextual information, wherein the CIB is adapted to obtain and store network contextual information and provide the contextual information to the SPF;
wherein the SPF includes means for utilizing the network contextual information to make the informed resource allocation/deallocation decisions.

10. The system according to claim 9, wherein the CIB also includes means for processing the network contextual information and storing the processed contextual information, wherein the CIB is adapted to provide the processed contextual information to the SPF.

11. The system according to claim 9, wherein the SPF includes logic for utilizing an upper limit policy to ensure that adequate network resources are available for new calls whenever the load on the IMS network is less than a predefined level, wherein a plurality of classes of differing priorities are defined for calls having different Quality of Service (QoS) profiles, and an upper limit is established on the amount of network resources that can be utilized for calls of each class, wherein when a given class has utilized its limit of network resources, additional requests for calls of the given class are rejected.

12. The system according to claim 11, wherein the SPF also includes logic for limiting multi-party calls to a predefined number of participants whenever the load on the IMS network is more than the predefined level.

13. The system according to claim 9, wherein the SPF also includes logic for sending triggers to the S-CSCF to re-negotiate media-format parameters of ongoing calls in response to updated network contextual information obtained from the CIB.

14. The system according to claim 9, further comprising a user equipment (UE) adapted to send to the S-CSCF, a call request which includes the class of the requested call, wherein the S-CSCF is adapted to receive the call request from the UE and to query the SPF for the informed resource allocation/deallocation decision.

15. The system according to claim 14, wherein the UE is further adapted to send to the S-CSCF during an ongoing call, a class change request which includes a new requested class for the ongoing call, wherein the S-CSCF is adapted to receive the class change request from the UE and to query the SPF for a second informed resource allocation/deallocation decision.

16. A Session Prioritization Function (SPF) for making informed resource allocation/deallocation decisions in an IP Multimedia Subsystem (IMS) network, said SPF comprising:
means for receiving from a Serving Call/Session Control Function (S-CSCF), a request for a resource allocation/deallocation decision;
means responsive to the request for obtaining network contextual information from a Context Information Base (CIB);
means for utilizing the network contextual information to make an informed resource allocation/deallocation decision; and
means for sending the informed resource allocation/deallocation decision to the S-CSCF.

17. The SPF according to claim 16, wherein the means for utilizing the network contextual information to make an informed resource allocation/deallocation decision includes:
a repository for session prioritization policies; and
logic for applying the network contextual information to the session prioritization policies to formulate the informed resource allocation/deallocation decision.

18. The SPF according to claim 17, wherein the logic for applying the network contextual information to the session prioritization policies to formulate the informed resource allocation/deallocation decision is adapted to utilize an upper limit policy to ensure that adequate network resources are available for new calls whenever the load on the IMS network is less than a predefined level, wherein a plurality of classes of differing priorities are defined for calls having different Quality of Service (QoS) profiles, and an upper limit is established on the amount of network resources that can be utilized for calls of each class, wherein when a given class has utilized its limit of network resources, additional requests for calls of the given class are rejected.

19. The SPF according to claim 18, wherein the logic for applying the network contextual information to the session prioritization policies to formulate the informed resource allocation/deallocation decision is also adapted to limit multi-party calls to a predefined number of participants whenever the load on the IMS network is more than the predefined level.

20. The SPF according to claim 16, further comprising logic for sending triggers to the S-CSCF to re-negotiate media-format parameters of ongoing calls in response to updated network contextual information obtained from the CIB.

21. The SPF according to claim 16, wherein the SPF is adapted to receive a session class change request from the S-CSCF, formulate a second informed resource allocation/deallocation decision, and return the second informed resource allocation/deallocation decision to the S-CSCF.

22. A Session Prioritization Function (SPF) for making an informed resource allocation/deallocation decision in an IP Multimedia Subsystem (IMS) network, said SPF comprising:
an interface to a Serving Call/Session Control Function (S-CSCF) for receiving from the S-CSCF, a request for a resource allocation/deallocation decision, and for sending the informed resource allocation/deallocation decision to the S-CSCF;
an interface to a Context Information Base (CIB);
an information access module for obtaining network contextual information from the CIB responsive to the request from the S-CSCF;
a repository for session prioritization policies; and
a control module for applying the network contextual information to the session prioritization policies to formulate the informed resource allocation/deallocation decision.
